(19) United States
(12) Patent Application Publication
(10) Pub. No.: US 2008/0320530 A1
(43) Pub. Date: Dec. 25, 2008

(54) Methods, apparatuses, and computer program products for delivering video on demand content

(76) Inventor: Timothy H. Weaver, Alpharetta, GA (US)

Correspondence Address: AT&T Legal Department;Attn: Patent Docketing, Room 2A-207, One AT&T Way, Bedminster, NJ, 07921, US

(21) Appl. No.: 11/510,928

(22) Filed: Aug. 28, 2006

Related U.S. Application Data
(60) Provisional application No. 60/711,884, filed on Aug. 26, 2005.

(51) Int. Cl. H04N 7/173

(52) U.S. Cl. 725/87

(57) ABSTRACT

Methods, apparatuses, and computer program products for delivering video on demand media content. The methods comprise receiving a selection of media content for viewing on demand; receiving an input specifying delayed viewing; determining that the media content is to commence before expiration of a predetermined time interval; determining whether or not any inputs from other viewers have been received that also specify delayed viewing of the same media content before expiration of the predetermined time interval; and if no such inputs from other viewers are received, then requesting a plurality of packets from the network, each of the packets bearing a unicast identifier corresponding to the selected media content; otherwise, requesting a plurality of packets from the network, each of the packets bearing a multicast identifier corresponding to the selected media content; receiving the plurality of packets; and delivering the plurality of packets for presentation of the media content.

### RELATED CASES

This application is based upon and claims priority under 35 USC §119(e) to Provisional Patent Application Ser. No. 60/711,884 filed on Aug. 26, 2005, the disclosure of which is incorporated herein in its entirety.

### BACKGROUND OF THE INVENTION

The present invention relates generally to delivery of media content in connection with a wide area data network and, more particularly, to methods, apparatuses, and computer program products for delivering video on demand content.

Delivering media content over a wide area data network is an increasingly popular method of transmitting audiovisual programs to viewers, enabling service providers to offer programming much more efficiently than in the case of traditional cable television systems. Internet protocol television (IPTV) represents one illustrative approach for delivering media content over a network. IPTV is ideal for programs intended for use by only a few subscribers, because a minimum amount of network resources are tied up to service this need. In contrast to broadcast television, IPTV has no inherent limitation on the total number of channels that can be offered for transmission. As a practical matter, the number of channels that can be carried to IPTV subscribers is significantly higher relative to traditional video delivery systems, limited only by the overall capacity of the network and the portion of the network which is allocated to IPTV services. Moreover, the same data transmission capacity of a network can be used for IPTV as well as other types of data traffic. IPTV sends audiovisual information over the network in the form of packet streams.

Wide area data networks may be used to provide customers with broadcast television programs including those carried by over-the-air broadcast stations and cable TV channels. They can also be used to provide subscribers with access to video-on-demand programs. Existing methods for delivering video-on-demand programs do not utilize the network in an efficient manner. These methods establish a unique video stream for each customer viewing a video-on-demand program including those that are viewing the same program at the same time. Because customers tend to use video-on-demand services at the same time of day, significant demands are placed on the wide area data network in terms of bandwidth and operational capacity during such periods. Since wide area data networks must be designed to deliver acceptable service quality during periods of heavy usage, the cost of providing video-on-demand services in this manner is unnecessarily high. During periods of heavy video-on-demand usage, the network may become congested, with the effect that packet throughput slows down, possibly interrupting the continuity of a program being viewed or making it necessary to deny service to a customer requesting a video-on-demand program In addition, the aggregate last mile network bandwidth required to deliver broadcast TV channels and video-on-demand programs to some customers may, at times, exceed the total amount of bandwidth available making it necessary to deny services to some customers during peak periods. By contrast, network utilization may be quite low during other time periods, such as 12:00 midnight to 4:00 AM, with the network having excess capacity that remains dormant. Existing approaches to delivering video-on-demand services do not efficiently utilize network capacity and do not exploit the unique capabilities of IPTV networks and current customer premises media storage technology. They do not consider current levels of network utilization and, instead, automatically initiate delivery of a program on request even if the network is already operating at or near capacity. Accordingly, what is needed is a technique for delivering video-on-demand programs over IPTV networks which increases network utilization efficiency relative to presently existing techniques and provides operators a choice of video-on-demand delivery options to satisfy customer demand during peak usage periods.

### BRIEF SUMMARY OF THE INVENTION

Exemplary embodiments include methods for delivering video-on-demand media content. These methods comprise receiving a selection of media content for viewing on demand; receiving an input specifying delayed viewing; determining that the media content is to commence before expiration of a predetermined time interval; determining whether or not any inputs from other viewers have been received that also specify delayed viewing of the same media content before expiration of the predetermined time interval; and if no such inputs from other viewers are received, then requesting a plurality of packets from the network, each of the packets bearing a unicast identifier corresponding to the selected media content; otherwise, requesting a plurality of packets from the network, each of the packets bearing a multicast identifier corresponding to the selected media content; receiving the plurality of packets; and delivering the plurality of packets for presentation of the media content.

Other exemplary embodiments include methods for delivering video-on-demand media content. These methods comprise receiving a selection of media content for viewing on demand; receiving an input specifying deferred viewing; determining that network utilization is less than a peak network utilization; requesting the media content; receiving the media content; and delivering the media content to a destination.

Other exemplary embodiments include computer program products for facilitating delivery of on demand media content. The computer program products comprise instructions for presenting for display an offer to select the media content; presenting for display options for at least two of: immediate viewing, delayed viewing, and deferred viewing; receiving a selection of media content for viewing; receiving an input specifying one of: immediate viewing, delayed viewing, or deferred viewing; sending a request for the media content, wherein the request includes an indication of the input specified; and receiving the media content.

Other methods, apparatuses, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of an exemplary system that may be utilized for delivering video-on-demand media content.

FIGS. 2A-2D together comprise a flow diagram of a first exemplary process for delivering video on demand media content.

FIG. 3 is a flow diagram of a second exemplary process for delivering video on demand media content.

The detailed description explains the exemplary embodiments, together with advantages and features, by way of example with reference to the drawings.

### DETAILED DESCRIPTION OF EXEMPLARY EMBODIMENTS

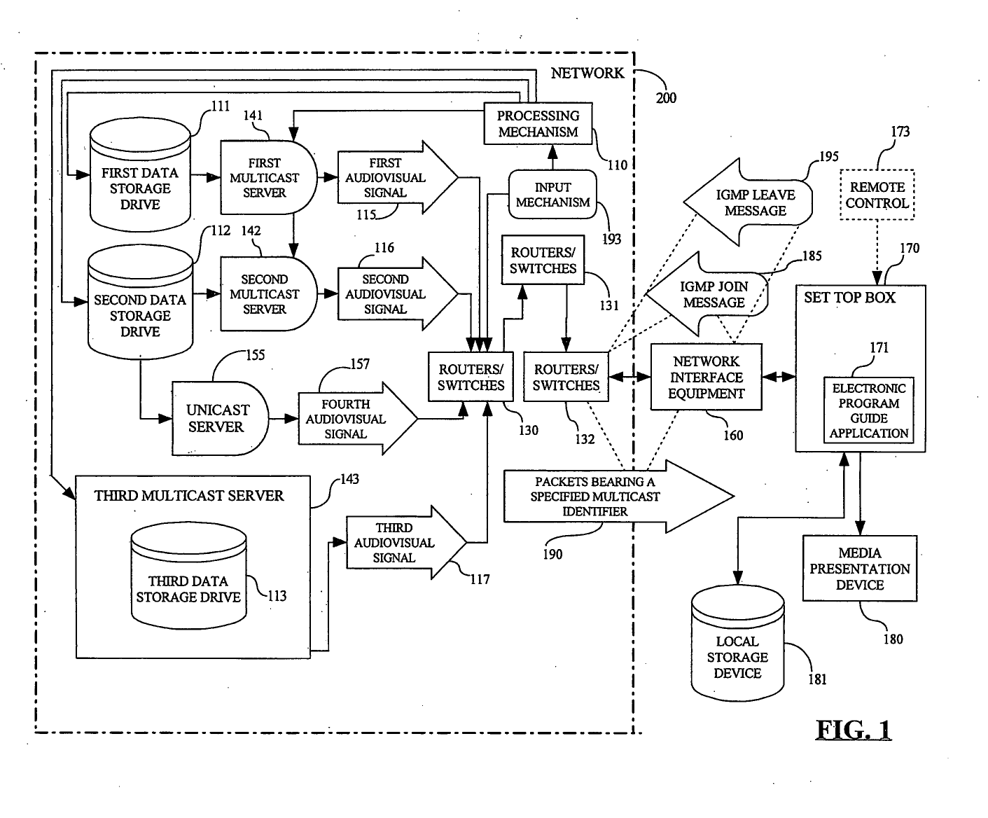

FIG. 1 is a block diagram of an exemplary system that may be utilized for delivering video on demand media content. A wide area data network 200 includes one or more data storage drives capable of electronically storing an audiovisual program for subsequent transmission to one or more viewers. Illustratively, these data storage drives include a first data storage drive 111, a second data storage drive 112, and a third data storage drive 113. First, second, and third data storage drives 111, 112, and 113 are each illustratively implemented using one or more computer hard drives, optical storage drives, magnetic tape drives, semiconductor memory, nanotechnology-based memory devices, or various combinations thereof. By way of example, a plurality of separate storage drives may be interconnected or networked to implement first data storage drive 111, or one or more of the first, second, and third data storage drives 111, 112, and 113 may be combined into a single integrated data storage drive.

First data storage drive 111 is operatively coupled to one or more multicast servers such as a first multicast server 141. Second data storage drive 112 is operatively coupled to a second multicast server 142 and a unicast server 155. Third data storage drive 113 is integrated within a third multicast server 143. First, second, and third multicast servers 141, 142, 143 and unicast server 155 are illustratively implemented using computer servers. Illustratively, one or more of the first, second, and third multicast servers 141, 142, 143 and unicast server 155 may be implemented using a single server. Pursuant to another illustrative example, one or more of the first, second, and third multicast servers 141, 142, 143 and unicast server 155 are each implemented using a plurality of servers.

First, second, and third multicast servers 141, 142, 143 and unicast server 155 are each capable of generating a corresponding sequence of packets in a digital format compatible with internet protocol (IP) networking. For example, first multicast server 141 generates a first program stream in the form of a first audiovisual signal 115. Similarly, second multicast server 142 generates a second program stream in the form of a second audiovisual signal 116. Third multicast server 143 generates a third program stream in the form of a third audiovisual signal 117. Unicast server 155 generates a fourth program stream in the form of a fourth audiovisual signal 157.

First, second, third, and fourth audiovisual signals 115, 116, 117, 157 may each represent a sequence of packets. Optionally, this sequence of packets may be compressed or processed to eliminate redundant information, thereby reducing the bandwidth occupied by one or more of the program streams. For example, IPTV digital video transmission methods currently employ standards developed by the Motion Pictures Expert Group (MPEG) for program stream formatting and network transport. These standards, known collectively as MPEG, define approaches for compressing video content to significantly reduce the bandwidth required for network transport. MPEG compression creates a stream of individual packets or frames, each carrying video content. Illustratively, the sequence of packets represented by first, second, third, and forth audiovisual signals 115, 116, 117 and 157 are each in a packetized format that complies with MPEG-4 standard H.264. First, second, and third audiovisual signals 115, 116, 117 represent multicast streams, whereas fourth audiovisual signal 157 represents a unicast stream.

A processing mechanism 110 is operatively coupled to first and second data storage drives 111, 112, and also to first, second, and third multicast servers 141, 142, 143. Processing mechanism 110 is illustratively implemented using one or more personal computers, mainframe computers, servers, microprocessor-based devices, or various combinations thereof. Separate elements may be used to implement processing mechanism 110, first data storage drive 111, second data storage drive 112, first multicast server 141, second multicast server 142, and third multicast server 143, or one or more of processing mechanism 110, first data storage drive 111, second data storage drive 112, first multicast server 141, second multicast server 142, and third multicast server 143 may be combined into a single element.

Processing mechanism 110 is capable of accepting input from an input mechanism 193. Input mechanism 193 could, but need not, be implemented using a modem, data receiver, computer keyboard, touch screen, pushbuttons, one or more switches, voice-activated software, personal computer, computer server, mainframe computer, laptop computer, computer console, or various combinations thereof. In practice, input mechanism 193 could, but need not, be combined with processing mechanism 110 such that input mechanism 193 and processing mechanism 110 are implemented by a single element such as a server, personal computer, or other device.

Input mechanism 193 is responsive to input from a system operator to control first multicast server 141, second multicast server 142, third multicast server 143, and unicast server 157. This operator input may provide one or more rules for controlling first multicast server 141, second multicast server 142, third multicast server 143, and unicast server 157 to reflect one or more operator policies.

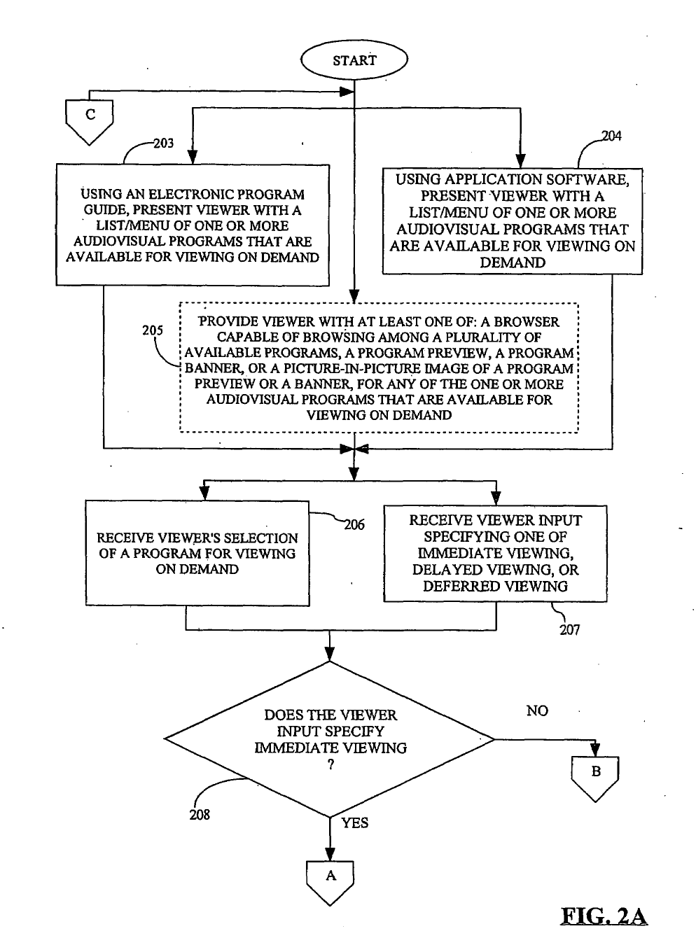

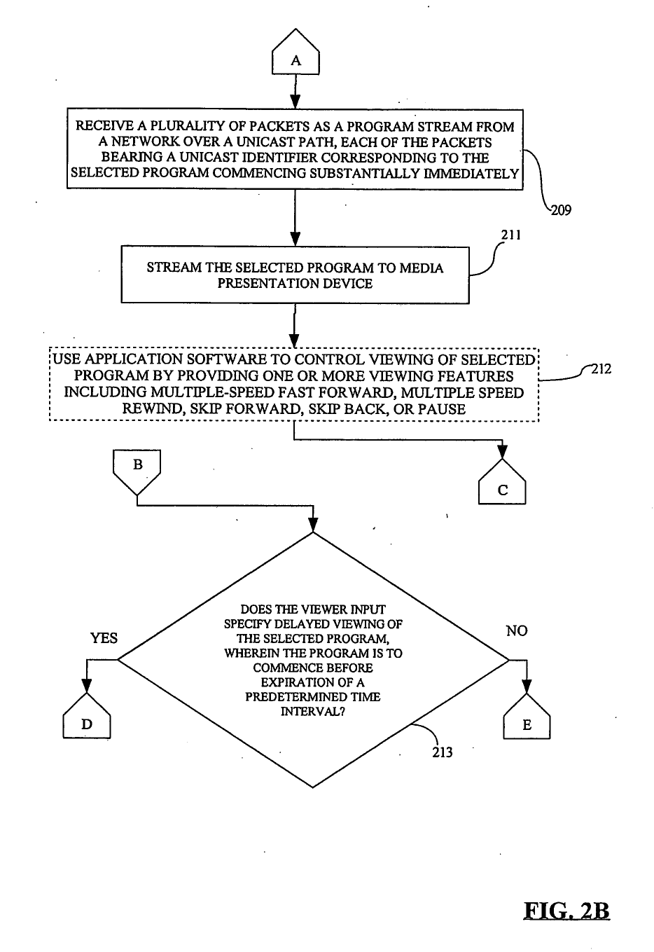

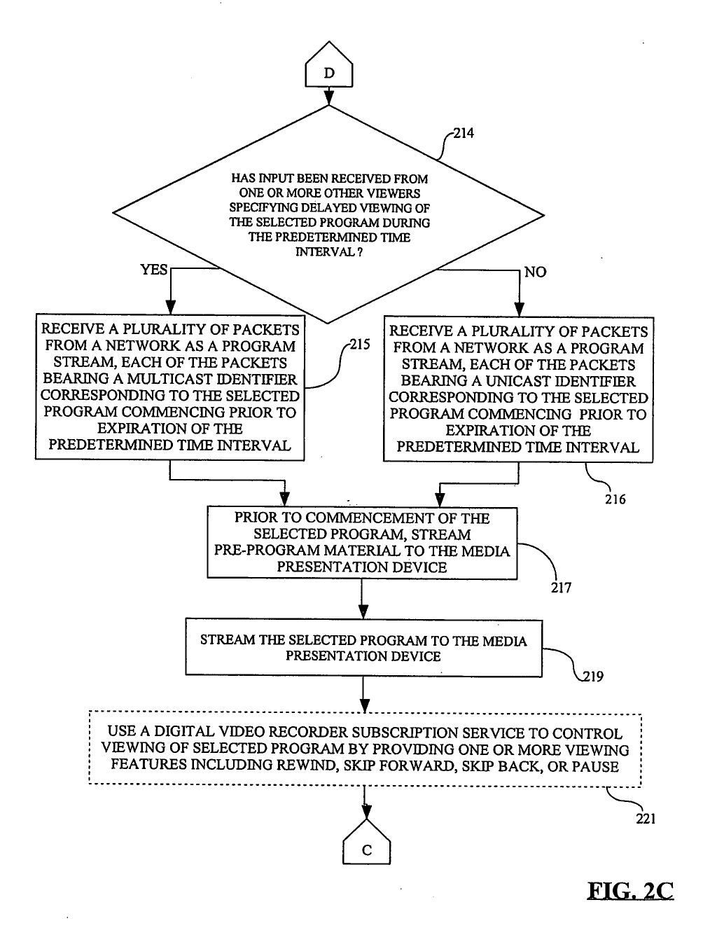

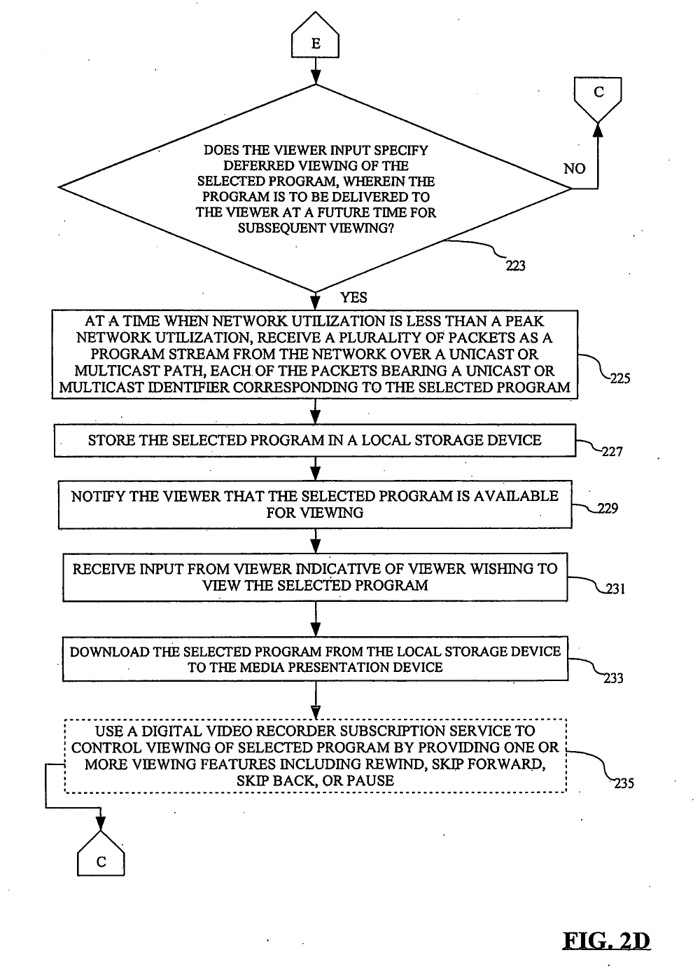

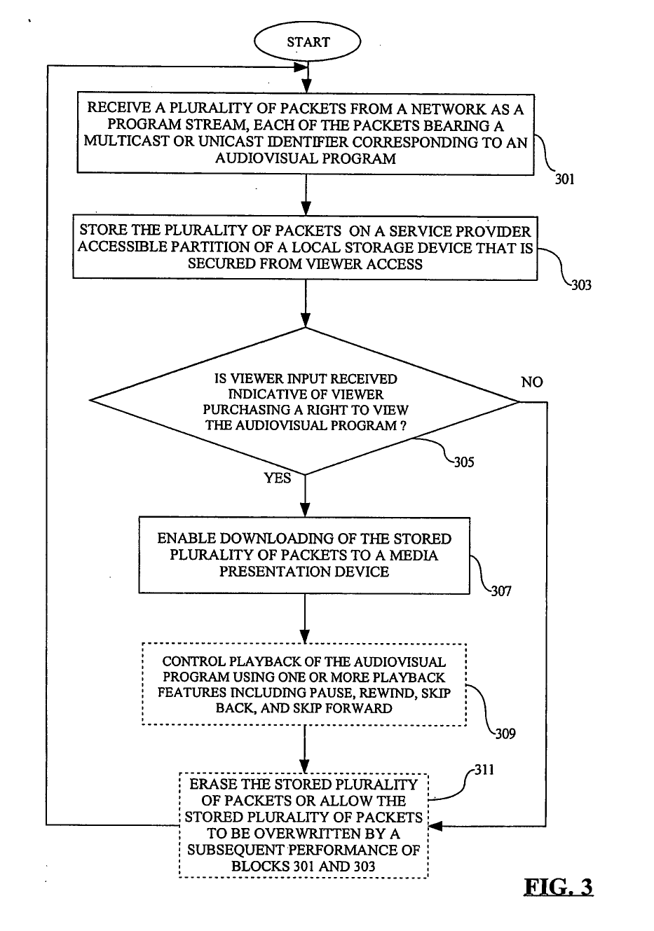

Input mechanism 193 is responsive to a viewer input received from an electronic program guide application 171 (to be described in greater detail hereinafter) and transmitted over routers/switches 132, 131, 130 via network interface equipment 160. This viewer input represents a request for on-demand viewing of an audiovisual program selected using electronic program guide application 171. The viewer input also specifies one of immediate viewing, delayed viewing, or deferred viewing (to be described in greater detail hereinafter with reference to FIGS. 2A-2D and 3). In response to input received at input mechanism 193 (FIG. 1), processing mechanism 110 may command any of first, second, or third multicast servers 141, 142, 143 to access a respective on-demand audiovisual program stored on any of the first, second, or third data storage drives 111, 112, 113, to generate a corresponding audiovisual signal such as first, second, or third audiovisual signal 115, 116, 117 including the respective on-demand audiovisual program.

By way of example, a viewer selects immediate viewing of a first audiovisual program using electronic program guide application 171. This selection is received by network interface equipment 160, routers 132, 131, 130, input mechanism 193, and processing mechanism 110. In response to receipt of the viewer selection, processing mechanism 110 commands first multicast server 141 to access the first audiovisual program which is stored on first data storage drive 111. First multicast server 141 generates a first multicast program stream in the form of first audiovisual signal 115. First audiovisual signal 115 includes the first audiovisual program.

Illustratively, in response to additional viewer selections received at input mechanism 193, processing mechanism 110 may command second multicast server 142 to access a second audiovisual program stored on second data storage drive 112 to generate a second multicast program stream in the form of second audiovisual signal 116 including the second audiovisual program. Similarly, in response to additional viewer selections received at input mechanism 193, processing mechanism 110 may command third multicast server 143 to access a third audiovisual program stored on third data storage drive 113 to generate a third multicast program stream in the form of third audiovisual signal 117 including the third audiovisual program. Accordingly, first, second, and third audiovisual signals 115, 116, 117, each representing streams of individual packets corresponding to respective first, second, and third multicast program streams pass through a series of routers/switches 130, 131, 132 until one or more of the streams reaches a viewer's location. First, second, and third audiovisual signals 115, 116, 117 are described only for purposes of illustration, it being understood that three signals are not required, as any number of one or more audiovisual signals may be provided.

At a viewer's location, network interface equipment 160 receives one of the first, second, and third multicast program streams from router/switch 132 on network 200. Network interface equipment 160 is operatively coupled to a set top box 170 using a wireless or wireline link and, illustratively, using an Ethernet link. Set top box 170 is operatively coupled to a media presentation device 180, such as a television set, video receiver, or the like using a wireless or wireline link and, illustratively, using coaxial cable carrying an RF-modulated signal. Alternatively or additionally, set top box 170 is coupled to media presentation device using a video connection such as S-Video or FireWire.

Set top box 170 is equipped with a processing mechanism, such as a microprocessor or microcontroller and associated semiconductor memory, for executing electronic program guide application 171. Electronic program guide application 171 causes media presentation device 180 to display an electronic program guide in the form of a list or menu of one or more audiovisual programs available for viewing on demand. Optionally, electronic program guide 171 may list one or more channels in addition to listing programs that are available for viewing on demand, wherein the one or more channels offer audiovisual programs associated with one or more corresponding scheduled broadcast times. Set top box 170 includes a channel/program selection mechanism capable of accepting a viewer input identifying one or more audiovisual programs for viewing on demand. This channel/program selection mechanism could, but need not, operate in conjunction with electronic program guide application 171, for example using optional remote control 173 or a touch-sensitive screen on media presentation device 180 to select a displayed audiovisual program or channel from the displayed electronic program guide. Alternatively or additionally, set top box 170 may include a channel/program selection mechanism such as a rotary switch and/or a channel/program selection mechanism operated using an optional remote control 173. Set top box 170 may, but need not, include circuitry for converting digital packets representing program streams received from network interface equipment 160 into analog or digital signals capable of being displayed on media presentation device 180.

If a viewer requests deferred viewing of an audiovisual program (to be described in greater detail with reference to FIGS. 2A-2D and 3), network 200 (FIG. 1) may download the program to network interface equipment 160 during a time when network usage is expected to be relatively low compared to a period of peak network usage. A local storage device 181 receives the downloaded program from network interface equipment 160. The downloaded program is stored on a service-provider controlled portion of local storage device 181 for subsequent viewing. Local storage device 181 may be implemented using a digital hard drive recording device (DVR). Local storage device 181 is partitioned such that a first portion of local storage device 181 is viewer accessible, whereas a second portion of local storage device 181 is secured from the viewer. The second portion of local storage device 181 is accessed by a service provider over network 200. Upon receipt of a viewer request to view a program stored in the second portion of local storage device 181, the service provider may enable viewer access to this stored program for viewing on media presentation device 180. Local storage device 181 may, but need not, be integrated into set top box 170. Moreover, set top box 170 may, but need not, be integrated into media presentation device 180.

Network interface equipment 160 receives a stream of internet protocol (IP) multicast or unicast packets representing an audiovisual program stream. Unicast refers to communication between a single sender and a single receiver, whereas multicast refers to communication between a single sender and multiple receivers. To avoid sending a multiplicity of different audiovisual program streams simultaneously over network 200, each respective audiovisual program stream uses a corresponding IP multicast identifier specific to that audiovisual program stream. Using Internet Group Management Protocol (IGMP), network interface equipment 160 communicates with network 200 to identify which audiovisual program the user desires to view or is currently viewing. For example, when a user enters an input into the channel/program selection mechanism on set top box 170, illustratively using an optional remote control 173 to select immediate viewing of a specified on-demand audiovisual program, set top box 170 transmits an IGMP join message 185 to the network 200.

IGMP join message 185 includes a channel/program identifier that identifies a channel or audiovisual program that the viewer desires to view or is currently viewing. IGMP join message 185 is sent in an “upstream” direction through routers/switches 132, 131, 130 in an attempt to locate an audiovisual program stream on network 200 corresponding to the channel/program identifier. When the appropriate audiovisual program stream is located, packets bearing a specified multicast identifier 190 for this stream are transmitted in a “downstream” direction from network 200 to network interface equipment 160 and set top box 170. Set top box 170 then relays the audiovisual program stream to media presentation device 180, such as an audiovisual program stream representing first audiovisual signal 115 and carrying a first audiovisual program for viewing on demand. Thereafter, when the user enters an input into the channel/program selection mechanism on set top box 170 indicating that he or she wishes immediate viewing of a second audiovisual program available for viewing on demand, set top box 170 transmits an IGMP leave message 195 to network 200 identifying the first audiovisual program, and transmits an IGMP join message 185 to the network 200 identifying the second audiovisual program.

As understood by one of ordinary skill in the relevant art, if a program is intended for one and only one subscriber, multicasting is replaced by unicasting. Both multicasting and unicasting fall within the scope of the instant teaching. An example of a unicast program would be a video-on-demand audiovisual program requested for immediate viewing by only one viewer, which by definition is intended for one and only one user destination.

FIGS. 2A-2D together comprise a flow diagram of a first exemplary process for delivering video-on-demand media content. Blocks 203, 204, and 205 (FIG. 2A) may be performed in any order or simultaneously. However, in an embodiment of the present invention, performance of all three blocks 203, 204, 205 is not required as, at a minimum, it is only necessary to perform one of the three blocks 203, 204 or 205. At block 203, using electronic program guide 170 (FIG. 1), a viewer is presented with a list or menu of one or more audiovisual programs that are available for viewing on demand. At block 204 (FIG. 2A), using application software running on set top box 170 (FIG. 1) or other customer premises equipment, a viewer is presented with a list or menu of one or more audiovisual programs that are available for viewing on demand. At block 205 (FIG. 2A), a viewer is provided with at least one of a browser capable of browsing among a plurality of available audiovisual programs, a program preview, a program banner, or a picture-in-picture image of a program preview or a banner, for any of one or more audiovisual programs that are available for viewing on demand.

After at least one of blocks 203, 204 and 205 have been executed, the process advances to blocks 206 and 207. Blocks 206 and 207 can be performed simultaneously or in any order. At block 206, a viewer's selection is received of an audiovisual program for viewing on demand. Illustratively, this selection can be received as an item selected from a list or menu, or by the viewer clicking on or touching a program preview, banner, or picture-in-picture image. At block 207, a viewer input is received specifying one of immediate viewing, delayed viewing, or deferred viewing for an audiovisual program available for viewing on demand. By pricing one or more of these options appropriately, economic incentives may be employed to motivate viewers to select an option that most efficiently meets their needs, effectively creating a method for rationing bandwidth. This method is roughly analogous to parcel delivery services wherein expedited delivery is priced higher than standard delivery.

A test is performed at block 208 to ascertain whether or not the viewer input specifies immediate viewing. If so, the process advances to block 209 (FIG. 2B) where a plurality of packets are received from network 200 (FIG. 1) as a program stream over a unicast path (i.e., from unicast server 155 and fourth audiovisual signal 157). Each of the packets bears a unicast identifier corresponding to the selected program commencing substantially immediately. Next, at block 211 (FIG. 2B), the selected program is streamed to media presentation device 180 (FIG. 1). Optionally, application software executed by set top box 170 or another item of customer premises equipment (not shown) is used to control viewing of the selected program by providing one or more viewing features including at least one of multiple-speed fast forward, multiple-speed rewind, skip forward, skip back, or pause (FIG. 2B, block 212).

The negative branch from block 208 (FIG. 2A) leads to block 213 (FIG. 2B) where a test is performed to ascertain whether or not the viewer input specifies delayed viewing of the selected program, wherein the program is to commence before expiration of a predetermined time interval. If so, the process advances to block 214 (FIG. 2C) where another test is performed to determine whether or not any inputs from one or more additional viewers have been received during the predetermined time interval that also specify delayed viewing of the same viewer selected program as was previously described in connection with block 206. If not, the process advances to block 216 where a plurality of packets are received from the network as a program stream, each of the packets bearing a unicast identifier corresponding to the selected program commencing prior to expiration of the predetermined time interval. The process then progresses to block 217, to be described in greater detail hereinafter.

The affirmative branch from block 214 leads to block 215 where a plurality of packets are received from the network as a program stream, each of the packets bearing a multicast identifier corresponding to the selected program commencing prior to expiration of the predetermined time interval. The process advances to block 217 where, prior to commencement of the selected program, pre-program material is streamed to the media presentation device. The selected program is then streamed to the media presentation device wherein the streaming commences prior to expiration of the predetermined time interval (block 219). Optionally, a digital video recorder subscription service may be employed to control viewing of the selected program by providing one or more viewing features including rewind, skip forward, skip back, or pause (block 221).

The negative branch from block 213 (FIG. 2B) leads to block 223 (FIG. 2D) where a test is performed to determine whether or not the viewer input specifies deferred viewing of the selected program, wherein the program is delivered to the viewer at a future time for subsequent viewing. If not, the process loops back to any of blocks 203, 204, or 205 (FIG. 2A) discussed previously. The affirmative branch from block 223 (FIG. 2D) leads to block 225 where, at a time when network utilization is expected to be relatively low compared with one or more peak periods of network utilization, a plurality of packets are received from the network over a unicast or multicast path as a program stream, each of the packets bearing a unicast or multicast identifier corresponding to the selected program.

At block 227, the selected program is stored in local storage device 181 (FIG. 1), and the viewer is notified that the selected program is available for viewing (FIG. 2D, block 229). Illustratively, block 229 may be performed by transmitting a notification signal over network 200 (FIG. 1) to network interface equipment 160, set top box 170, and media presentation device 180, causing a visual or audible or audiovisual indication to be rendered by media presentation device 180. For example, a semi-transparent icon appearing in a corner of an electronic display screen of media presentation device 180 could, but need not, be used as a suitable visual indication that the selected program is available for viewing.

Next, at block 231 (FIG. 2D), input from the viewer is received (for example, using optional remote control 173 of FIG. 1) indicative of the viewer wishing to view the selected program. The selected program is streamed from the local storage device to the media presentation device (FIG. 2D, block 233). Optionally, a digital video recorder subscription service may be employed to control viewing of the selected program by providing one or more viewing features including rewind, skip forward, skip back, or pause (block 235). The process then loops back to any of blocks 203, 204, or 205 (FIG. 2A) described previously.

FIG. 3 is a flow diagram of a second exemplary process for delivering video on demand media content. The process commences at block 301 where a plurality of packets are received from network 200 (FIG. 1) as a program stream, each of the packets bearing a multicast or unicast identifier corresponding to a selected item of media content. Next (FIG. 3, block 303), the plurality of packets are stored secured from a viewer on a service provider controlled partition of local storage device 181 (FIG. 1). The plurality of packets are secured from the viewer in the sense that the viewer cannot initiate playback of the plurality of packets at will unless playback is subsequently enabled by the service provider over the network.

At block 305 (FIG. 3), a test is performed to ascertain whether or not a viewer input is received indicative of the viewer purchasing a right to view the audiovisual program. If so, downloading of the stored plurality of packets to media presentation device 180 (FIG. 1) is enabled at block 307 (FIG. 3), wherein the stored plurality of packets represent the audiovisual program. Optionally, playback of the downloaded audiovisual program is controlled (block 309) using one or more playback features including pause, rewind, skip back, and skip forward. Next, at optional block 311, the stored plurality of packets are erased or the stored plurality of packets are allowed to be overwritten by a subsequent performance of blocks 301 and 303. The plurality of packets may be erased by means of a service provider command sent over network 200 (FIG. 1) and received by network interface equipment 160. After block 311 (FIG. 3), the process loops back to block 301. The negative branch from block 305 also leads back to block 301.

The detailed description explains various exemplary embodiments, together with advantages and features, by way of example with reference to the drawings. As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for delivering on demand media content, the method comprising:
receiving a selection of media content for viewing on demand;
receiving an input specifying delayed viewing;
determining that the media content is to commence before expiration of a predetermined time interval;
determining whether or not any inputs from other viewers have been received that also specify delayed viewing of the same media content before expiration of the predetermined time interval and;
if no such inputs from other viewers are received, then requesting a plurality of packets from the network, each of the packets bearing a unicast identifier corresponding to the selected media content;
otherwise, requesting a plurality of packets from the network, each of the packets bearing a multicast identifier corresponding to the selected media content;
receiving the plurality of packets; and
delivering the plurality of packets for presentation of the media content.

2. The method of claim 1 wherein delivering the plurality of packets includes streaming the plurality of packets to a media presentation device.

3. The method of claim 2 wherein streaming the plurality of packets includes streaming pre-program material to the media presentation device.

4. The method of claim 3 wherein the pre-program material includes any of: an advertisement, an informational announcement, a coming attraction, a graphical display, a pictorial display, musical programming, a corporate logo, or various combinations thereof.

5. A method for delivering on demand media content, the method comprising:
receiving a selection of media content for viewing on demand;
receiving an input specifying deferred viewing;
determining that network utilization is less than a peak network utilization;
requesting the media content;
receiving the media content; and
delivering the media content to a destination.

6. The method of claim 5 further including storing the media content in a local storage device.

7. The method of claim 6 further including storing pre-program material comprising any of: an advertisement, an informational announcement, a coming attraction, a graphical display, a pictorial display, musical programming, a corporate logo, or various combinations thereof.

8. The method of claim 5 further including providing a notification to the viewer that the selected media content is available for viewing.

9. A computer program product for facilitating delivery of on demand media content, comprising instructions for:
presenting for display an offer to select the media content;
presenting for display options for at least two of: immediate viewing, delayed viewing, and deferred viewing;
receiving a selection of media content for viewing;
receiving an input specifying one of: immediate viewing, delayed viewing, or deferred viewing;
sending a request for the media content, wherein the request includes an indication of the input specified; and
receiving the media content.

10. The computer program product of claim 9 further comprising instructions for receiving a plurality of packets from a network over a unicast path if the viewer input specifies immediate viewing, each of the packets bearing a unicast identifier corresponding to the viewer selected media content commencing substantially immediately;

11. The computer program product of claim 9 further comprising instruction for determining whether or not any inputs from other viewers have been received that also specify delayed viewing of the viewer selected media content within the predetermined time interval if the viewer input specifies delayed viewing of the selected media content such that the selected media content is to commence before expiration of a predetermined time interval.

12. The computer program product of claim 11 further comprising instructions for receiving a plurality of packets from the network if no input from other viewers has been received that specifies delayed viewing, wherein each of the packets bears a unicast identifier corresponding to the selected media content commencing before expiration of a predetermined time interval.

13. The computer program product of claim 11 further comprising instructions for receiving a plurality of packets from the network if at least one input from another viewer has been received that specifies delayed viewing, wherein each of the packets bears a multicast identifier corresponding to the selected media content commencing before expiration of a predetermined time interval.

14. The computer program product of claim 9 wherein, if the viewer input specifies deferred viewing of the selected media content wherein the program is delivered to the viewer at a future time for subsequent viewing, then the computer program product further comprises instructions for receiving a plurality of packets from the network over a unicast or multicast path at a time when network utilization is less than a peak network utilization, each of the packets bearing a unicast or multicast identifier corresponding to the selected media content.

15. The computer program product of claim 14 further comprising instructions for storing the selected media content in a local storage device.

16. The computer program product of claim 15 further comprising instructions for providing a notification to the viewer that the selected media content is available for viewing.

17. The computer program product of claim 16 further including instructions for erasing the stored plurality of packets if a viewer input is not received indicative of the viewer purchasing a right to view the selected media content.

18. The computer program product of claim 16 further including instructions for allowing the stored plurality of packets to be overwritten by a subsequent storing of a plurality of packets if a viewer input is not received indicative of the viewer purchasing a right to view the selected media content.

19. The computer program product of claim 9 wherein the received media content includes pre-program material.

20. The computer program product of claim 19 wherein the pre-program material includes any of: an advertisement, an informational announcement, a coming attraction, a graphical display, a pictorial display, musical programming, a corporate logo, or various combinations thereof.
